(19) United States
(12) Patent Application Publication
(10) Pub. No.: US 2002/0094945 A1
(43) Pub. Date: Jul. 18, 2002

(54) Reaction products of alkoxylated compounds and polyepoxides

(76) Inventors: Stephen F. Gross, Souderton, PA (US); Wei Li, Mason, OH (US); Norman Tuller, Simpsonville, SC (US); Michael S. Wiggins, Lansdale, PA (US)

Correspondence Address: COGNIS CORPORATION, 2500 RENAISSANCE BLVD., SUITE 200, GULPH MILLS, PA, 19406

(21) Appl. No.: 09/999,290

(22) Filed: Nov. 15, 2001

Related U.S. Application Data
(60) Provisional application No. 60/256,375, filed on Dec. 18, 2000.
(60) Provisional application No. 60/296,933, filed on Jun. 8, 2001.

(51) Int. Cl. C11D 3/37

(52) U.S. Cl. 510/475

(57) ABSTRACT

Reaction products of the reaction between reactants comprising

A) at least one compound having the formula I below

R X(EO)ₙ(PO)ₘ(BO)ₚZ (I)

wherein R is a substituted or unsubstituted, saturated or unsaturated, organic group having from 4 to 36 carbon atoms; X is —O—, —S—, or —NR¹— where R¹ is hydrogen or a C₁-C₈ alkyl group; Z is hydrogen, —NHR¹ in place of a terminal —O— group wherein R¹ has the meaning given above, or —SH in which the —SH group is present in place of a terminal —O— group; n is a number of from 0 to 100; m is a number of from 0 to 50; and p is a number of from 0 to 50; provided that the sum of n, m, and p is at least 1; wherein EO represents the residue of ethylene oxide, PO represents the residue of propylene oxide, and BO represents the residue of butylene oxide; and wherein the EO, PO, and BO groups when present can be in random and/or block distribution and can be in any order with respect to the X group; and

B) a polyepoxide of formula II below

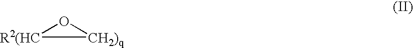

wherein R² is hydrogen or a substituted or unsubstituted C₁ to C₃₀ organic group, and q is a number of from 2 to 10; and aqueous and nonaqueous compositions containing them.

### CROSS REFERENCE TO RELATED APPLICATIONS

This application claims the benefit of copending provisional application serial No. 60/256,375, filed on Dec. 18, 2000, and provisional application serial No. 60/296,933 filed on Jun. 8, 2001; the entire contents of each of which are incorporated herein by reference.

### FIELD OF THE INVENTION

This invention relates to compounds useful as low foaming surfactants and as defoaming agents in aqueous and nonaqueous liquid compositions.

### BACKGROUND OF THE INVENTION

Aqueous cleaning compositions exhibit a tendency toward foaming since they contain surface active agents such as soaps, and synthetic detergents. In many instances, such cleaning compositions produce excessive foam and the user must add substances known as anti-foaming agents or defoamers. Some defoamers such as silicones tend to interfere with the function of the cleaning compositions in that unwanted residues are left after the cleaners are wiped off, while others are environmentally unacceptable because they are not biodegradable.

Alkyl polyglycosides are a class of nonionic surfactants that exhibit significantly higher foaming profiles than other nonionic surfactants, such as alcohol ethoxylates. In fact, the foaming tendencies of alkyl polyglycosides more closely resemble those of anionic surfactants, such as alcohol sulfates, than the foaming tendencies of other nonionic surfactants. This higher foaming tendency makes the use of alkyl polyglycosides alone undesirable for many applications, e.g. cleaning-in-place for food processing plants, high pressure spray cleaning, bottle washing, floor cleaners and automatic dishwashing, wherein high levels of foam interfere with the cleaning and rinsing operation and reduce the efficiency of the operation.

Low foam nonionics, such as EO/PO block copolymers, can be used to reduce the foaming properties of alkyl polyglycosides and anionic surfactants, but these materials have undesirable properties, e.g. low biodegradability, relatively high aquatic toxicity and poor caustic compatibility.

Accordingly, there is a need for the development of defoamers that do not interfere with the cleaning ability of aqueous cleaning compositions and that are biodegradable, exhibit low aquatic toxicity, and good caustic compatibility.

There is also a need for defoamers for nonaqueous compositions.

In addition, there is a continuing need for low foaming surfactants for use in both aqueous and nonaqueous compositions.

### SUMMARY OF THE INVENTION

This invention relates to the reaction products of alkoxylated compounds and polyepoxides useful as low foaming surfactants and as defoaming agents in aqueous and nonaqueous liquid compositions.

In particular, the reaction products of the invention are the reaction products of the following reactants:

A) at least one compound of formula I

R X(EO)ₙ(PO)ₘ(BO)ₚZ (I)

wherein R is a substituted or unsubstituted, saturated or unsaturated, organic group having from 4 to 36 carbon atoms; X is —O—, —S—, or —NR¹— where R¹ is hydrogen or a C₁-C₈ alkyl group; Z is hydrogen, —NHR¹ in place of a terminal —O— group wherein R¹ has the meaning given above, or —SH in which the —SH group is present in place of a terminal group —O— group; n is a number of from 0 to 100, e.g., from 1 to 100; m is a number of from 0 to 50 e.g., from 1 to 50; and p is a number of from 0 to 50 e.g., from 1 to 50; provided that the sum of n, m, and p is at least 1; wherein EO represents the residue of ethylene oxide, PO represents the residue of propylene oxide, and BO represents the residue of butylene oxide; and wherein the EO, PO, and BO groups when present can be in random and/or block distribution and can be in any order with respect to the X group; and

B) a polyepoxide of formula II

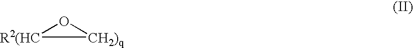

wherein R² is hydrogen or a C₁ to C₃₀ substituted or unsubstituted organic group, preferably a straight or branched chain alkyl or arenyl group, or an alkyl or arenyl group containing one or more ether groups and/or one or more hydroxyl groups, or an aromatic group; and q is a number of from 2 to 10.

### DESCRIPTION OF THE PREFERRED EMBODIMENTS

Other than in the operating examples, or where otherwise indicated, all numbers expressing quantities of ingredients or reaction conditions used herein are to be understood as modified in all instances by the term “about”. Also, throughout this description, unless expressly stated to the contrary; percent, “parts” of, and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description or of generation in situ by chemical reactions specified in the description, and does not necessarily preclude other chemical interactions among the constituents of a mixture once mixed.

In the branched compounds used in the practice of the invention, in the formula I reactant, formula I compounds wherein the sum of n, m, and p is at least 2, especially at least 3, are preferred. Examples of R groups include substituted or unsubstituted alkyl groups having from 4 to 36 carbon atoms, preferably from 4 to 22 carbon atoms, alkenyl and alkynyl groups having from 4 to 36 carbon atoms, preferably from 4 to 22 carbon atoms, aryl groups having from 6 to 26 carbon atoms, and arenyl groups having from 7 to 36 carbon atoms. When the above groups are substituted groups, the groups can contain single or multiple substitutions such as a halogen substitution, for example Cl, Fl, I, and Br; a sulfur functionality such as a mercaptan or thio group; a nitrogen functionality such as an amine or amide functionality; a silicon functionality; or any combination thereof.

The R group can be any substituted or unsubstituted, saturated or unsaturated organic moiety having from 4 to 36 carbon atoms. Thus, the R groups can be linear or branched alkyl groups, linear or branched alkenyl or alkynyl groups, saturated carbocyclic moieties having one or more multiple bonds, saturated heterocyclic moieties, unsaturated heterocyclic moieties having one or more multiple bonds, substituted linear or branched alkyl groups, substituted linear or branched alkenyl or alkynyl groups, substituted saturated carbocyclic moieties, substituted unsaturated carbocyclic moieties having one or more multiple bonds, substituted saturated heterocyclic moieties, and substituted unsaturated heterocyclic moieties having one or more multiple bonds. Examples of the above include but are not limited to an alkyl group having from 4 to 22 carbon atoms, an alkenyl group having from 4 to 22 carbon atoms, and an alkynyl group having from 4 to 22 carbon atoms. R can also be an arenyl group. Arenyl groups are alkyl-substituted aromatic radicals having a free valence at an alkyl carbon atom such as a benzylic group. Alkyl groups having from 4 to 12 carbon atoms are preferred, and alkyl groups having from 8 to 10 carbon atoms are most preferred. The degree of ethoxylation is preferably from 2 to about 50, more preferably from 3 to about 50, with the most preferred being from 4 to 50, while the degree of propoxylation and butoxylation can vary from 0 to about 50, e.g. from 0 to about 10. The degree of propoxylation and/or butoxylation will be determined by the desired degree of water solubility and miscibility. The water solubility or miscibility will ultimately be determined by such factors as the number of carbon atoms in R, the relative amounts of EO, PO, and BO, and the effect of PO and BO on the biodegradability of the branched compound. The water solubility or miscibility of a branched compound according to the invention and the interrelationships between the number of carbon atoms in R group, the relative amounts of EO, PO, and BO and the biodegradability of the final product will be readily determinable by one of ordinary skill in the art.

When the Z group of formula I is a mercapto group, examples of such compounds include but are not limited to, alkoxylated dodecyl mercaptan and alkoxylated 1-hexadecanethiol.

When the X group is —NR¹—, the compounds of formula I are alkoxylated amines. When the compounds of formula I are alkoxylated amines, n is a number from 0 to 50, preferably from 1 to 50, m is a number from 0 to 50 and p is a number from 0 to 50, preferably from 1 to 50, provided that the sum of n, m, and p is at least 1. Examples of the alkoxylated amines useful for the purposes of the invention include but are not limited to, alkoxylated dibutyl amine, alkoxylated dicyclohexyl amine, alkoxylated diethylethanolamine, and alkoxylated dioctylamine.

In the compounds of formula I where Z is —NHR¹, the corresponding compound of formula I wherein Z is —OH can be converted to —Cl or —Br and then reacted with ammonia or a C₁-C₈ primary amine. Where Z is —SH, the corresponding compound in which Z is —OH can be converted to the mercaptan by methods well known to the art, e.g. by the reaction of the corresponding —Cl or —Br compound with sodium hydrosulfide.

Preferred compounds of formula I have the following formula III:

R O(EO)ₙ(PO)ₘ(BO)ₚH (III)

in which R, n, m, and p have the meanings given above.

In the compounds of formula I and III, it is understood that EO stands for the residue of ethylene oxide, PO stands for the residue of propylene oxide, and BO stands for the residue of butylene oxide. Also, in the compounds of formula I and III, the EO, PO, and BO groups, when present, can be in any order with respect to the RX or RO group, and can be in blocks and/or in random distribution, although the alkoxide groups present are preferably present in the order shown in formulae I and III.

In the polyepoxides of formula II, q is preferably a number of from 2 to 4, and R² is preferably an organic group, preferably an alkyl group, optionally containing one or more ether groups and/or one or more hydroxyl groups, and having from 2 to 12 carbon atoms. Where R² is an aromatic group, the group is preferably a substituted or unsubstituted phenyl or phenoxy group, although other aromatic groups can also be used, e.g. naphthalene and naphthyleneoxy groups and the like. The substituents that can be present on the R² group include one or more of the following: halogen atoms, i.e. Fl, Cl, Br, and I; C₁-C₄ alkyl groups; hydroxyl groups; C₁-C₄ alkoxy groups; a sulfur functionality such as a mercaptan or thio group; a nitrogen functionality such as an amine or amide group; and the like.

Examples of compounds of formula II include adducts of glycerol diglycidyl ether, diepoxybutane, triepoxyhexane, triepoxyoctane, phenyl diepoxybutane, and the like.

The equivalent ratio of the Z groups of formula I and the epoxide groups of formula II used in preparing the reaction products of the invention can range from 2:1 to 1:1, preferably from 1.2:1 to 1:1, and more preferably about 1:1. Greater quantities of the compound of formula I can be used but no advantages result therefrom.

The reaction between reactants A) and B) can be carried out by reacting the components at a temperature in the range of from 90 to 150° C., preferably from 120 to 140° C. The reaction is carried out using an aqueous alkaline catalyst, preferably aqueous concentrated sodium or potassium hydroxide. It is also preferred to carry out the reaction in an inert atmosphere such as a nitrogen atmosphere, and by slowly adding the component B) polyepoxide to a mixture of component A) and the alkaline catalyst.

The resulting reaction products are or include compounds of the formula IV

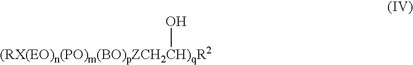

in which R, X, n, m, p, q, and R² have the meanings given above, and Z is either not present or is —NR¹— or —S— in place of an —O— group.

The reaction products of the invention can be used as low foaming surfactants in both aqueous and nonaqueous compositions in surfactant-effective amounts, usually from 0.1 to 10% by weight, preferably from 1 to 5% by weight, based on the weight of the composition.

These reaction products can also be used in the above quantities as defoaming agents for aqueous and nonaqueous compositions, and are particularly useful in minimizing or eliminating foaming in aqueous compositions containing high foaming surfactants, such as alkyl polyglycosides and anionic surfactants such as alcohol sulfates.

These reaction products can be used in the aqueous cleaning compositions, in emulsion polymer latex compositions such as latex paints, in inks, in adhesives, in metal working compositions, and in other aqueous and nonaqueous compositions in which surfactants and/or defoaming agents are advantageously present.

The reaction products of the invention are biodegradable, contain no organic solvents, and do not adversely affect the detergency of other surfactants that may be present in compositions in which they are used since they are themselves surfactants.

The invention will be illustrated but not limited by the following example.

### EXAMPLE

### Synthesis of Glycerol Diglycidyl Ether and POE (6) Tridecyl Alcohol Adduct

92.95 g (0.200 mol) of POE (6) Tridecyl alcohol was charged to a 250 ml three neck flask, which was equipped with a condenser, a nitrogen inlet, and a thermometer. The flask was purged with nitrogen for 10 minutes while stirring. 4.02 g of 50 wt. % NaOH (0.050 mole) was added and stirred for 20 min. at room temperature. 33.93 g, 0.166 mol, of Glycerol diglycidyl ether was added dropwise. The flask was again purged with nitrogen for 10 minutes while stirring, and then heated up to 140° C. for 14.0 hr under nitrogen. It was then cooled down to 80° C., and 5.45 g of 70 wt. % glycolic acid (0.050 mole) was added to neutralize NaOH. The mixture was heated up to 105° C. and held for 4 hr. After cooling down to ambient temperature, vacuum distillation was run on a rotavapor to remove water, and filtered to remove the solid phase. The filtrate was collected as product.

What is claimed is:

1. The reaction product of the reaction between reactants comprising
A) at least one compound having the formula I below
R X(EO)ₙ(PO)ₘ(BO)ₚZ (I)
wherein R is a substituted or unsubstituted, saturated or unsaturated, organic group having from 4 to 36 carbon atoms; X is —O—, —S—, or —NR¹— where R¹ is hydrogen or a C₁-C₈ alkyl group; Z is hydrogen, —NHR¹ in place of a terminal —O— group wherein R¹ has the meaning given above, or —SH in which the —SH group is present in place of a terminal group; n is a number of from 0 to 100; m is a number of from 0 to 50; and p is a number of from 0 to 50; provided that the sum of n, m, and p is at least 1; wherein EO represents the residue of ethylene oxide, PO represents the residue of propylene oxide, and BO represents the residue of butylene oxide; and wherein the EO, PO, and BO groups when present can be in random and/or block distribution and can be in any order with respect to the X group; and
B) a polyepoxide of formula II below 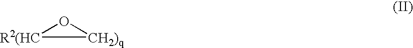
wherein R² is hydrogen or a substituted or unsubstituted C₁ to C₃₀ organic group, and q is a number of from 2 to 10.

2. The reaction product of claim 1 wherein in component A) the sum of n, m, and p is at least 2.

3. The reaction product of claim 2 wherein the sum of n, m, and p is at least 3.

4. The reaction product of claim 1 wherein in component A), R is an alkyl group containing from 4 to 12 carbon atoms.

5. The reaction product of claim 4 wherein the alkyl group contains from 8 to 10 carbon atoms.

6. The reaction product of claim 1 wherein in component A), X is —O—.

7. The reaction product of claim 1 wherein in component A), Z is hydrogen.

8. The reaction product of claim I wherein in component A), n is a number of from 2 to about 50.

9. The reaction product of claim 1 wherein component A) has the formula
RO(EO)ₙ(PO)ₘ(BO)ₚH (III)
where R, n, m, and p have the meanings given in claim 1.

10. The reaction product of claim 9 wherein R is an alkyl group containing from 4 to 12 carbon atoms and n is a number of from 4 to about 50.

11. The reaction product of claim 9 wherein the alkoxide groups present are present in the order shown in formula III.

12. The reaction product of claim 1 wherein in component A) wherein the alkoxide groups present are present in the order shown in formula I.

13. The reaction product of claim 1 wherein in component B), R² is a substituted or unsubstituted alkyl or alkoxy group having from 2 to 12 carbon atoms.

14. The reaction product of claim 13 wherein in component B), q is a number of from 2 to 4.

15. The reaction product of claim 1 wherein the equivalent ratio of the Z groups in the compounds of formula I to the epoxide groups in the compounds of formula II is from about 2:1 to 1:1.

16. The reaction product of claim 15 wherein the equivalent ratio is from about 1.2:1 to 1:1.

17. The reaction product of claim 1 having the formula IV below 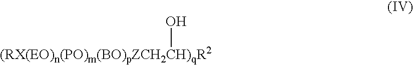
in which R, X, n, m, p, q, and R² have the meanings given in claim 1, and Z is not present or is —NR¹— or —S— in place of an —O— group.

18. The reaction product of claim 18 wherein X is and Z is not present, and the EO, PO, and BO groups present are in the order shown in formula IV.

19. In an aqueous composition, the improvement wherein a surfactant-effective or defoaming-effective quantity of the reaction product of claim 1 is present therein.

20. The composition of claim 19 wherein the surfactant-effective or defoaming-effective quantity is from about 0.1 to about 10% by weight.

21. The composition of claim 19 wherein the composition is a latex paint composition.

22. In an aqueous composition containing an allyl polyglycoside and/or an alcohol sulfate the improvement wherein a defoaming-effective quantity of the reaction product of claim 1 is present therein.

23. In a nonaqueous liquid composition, the improvement wherein a surfactant-effective or defoaming-effective quantity of the reaction product of claim 1 is present therein.

24. The nonaqueous liquid composition of claim 23 wherein the composition is an ink, an adhesive, or a metal working composition.

25. The nonaqueous liquid composition of claim 23, wherein the surfactant-effective quantity is from about 0.1 to about 10% by weight.

26. The reaction product of claim 1 wherein R in component A) is an unsubstituted group and the EO, PO, and BO groups when present are in the order shown in formula I, and the R² group in formula II is hydrogen or a C₂-C₁₂ organic group.

27. The reaction product of claim 9 wherein R in component A) is an unsubstituted group, and the EO, PO, and BO groups when present are in the order shown, and the R₂ group in formula II is hydrogen or a C₂-C₁₂ organic group.
